(19) United States
(12) Patent Application Publication
(10) Pub. No.: US 2020/0079267 A1
(43) Pub. Date: Mar. 12, 2020

(54) EZ MINI TRANSPORT TRAILER

(71) Applicant: Susan Burton, Plymouth, MI (US)

(72) Inventor: Susan Burton, Plymouth, MI (US)

(21) Appl. No.: 16/127,012

(22) Filed: Sep. 10, 2018

(51) Int. Cl. B60P 1/43; B62D 63/06; B62D 63/08

(52) U.S. Cl. CPC B60P 1/431; B62D 63/08; B62D 63/062

(57) ABSTRACT

An improved transport trailer is presented. The improved transport trailer has a storage compartment. The storage compartment has a bottom, a front side, a left side, a back side and a right side. The left side, back side and the right side have a barrier. The barrier keeps items in the storage compartment when the transport trailer is in transit. The open side having a ramp and the ramp is for moving items in and out of the storage compartment. The bottom also has a ramp storage area for storing the ramp.

### FIELD OF THE INVENTION

This invention relates to apparatus for transport trailers. More particularly, it relates to transport trailer with loading ramps.

### BACKGROUND

Traditional trailers may include a gate ramp that is connected to the trailer bed in such a manner that it functions as a gate when it is raised vertically and as a ramp when it is lowered. However, when traveling at highway speeds the gate ramp creates considerable wind resistance, which is detrimental to the fuel efficiency of the towing vehicle.

Removing the gate ramp from the rear of said trailer can eliminate the problem associated with wind resistance, and placing said gate ramp along a side of said trailer or upon the trailer bed.

As a preliminary note, it should be stated that there is an ample amount of prior art that deals with trailers, trailer ramps, and trailer accessories. However, as will be discussed immediately below, no prior art discloses a connection assembly that enables a trailer ramp or gate ramp to be either installed or removed from a trailer by a single person.

Some commercial trailers allow for the removal and attachment of the gate ramp by having two connection units that do not have a cutaway section on the connections. To reattach said gate ramp requires the use of two people, on either side, to lift the gate ramp and position the two connection units in perfect alignment with their pins and then pull the ramp gate to the side to cause the two pins to be inserted in their respective connection simultaneously.

While the above described devices fulfill their respective and particular objects and requirements, they do not describe a gate or ramp that enables a gate or ramp that can be easily stored in a trailer and can be easily accessed from the trailer by a single person.

### BRIEF DESCRIPTION OF THE DRAWINGS

FIG. 1 is a view of a traditional transport trailer.

FIG. 2 is a view of an exemplary improved transport trailer with the ramp stowed.

FIG. 3 is view of an exemplary improved transport trailer with the ramp extended.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

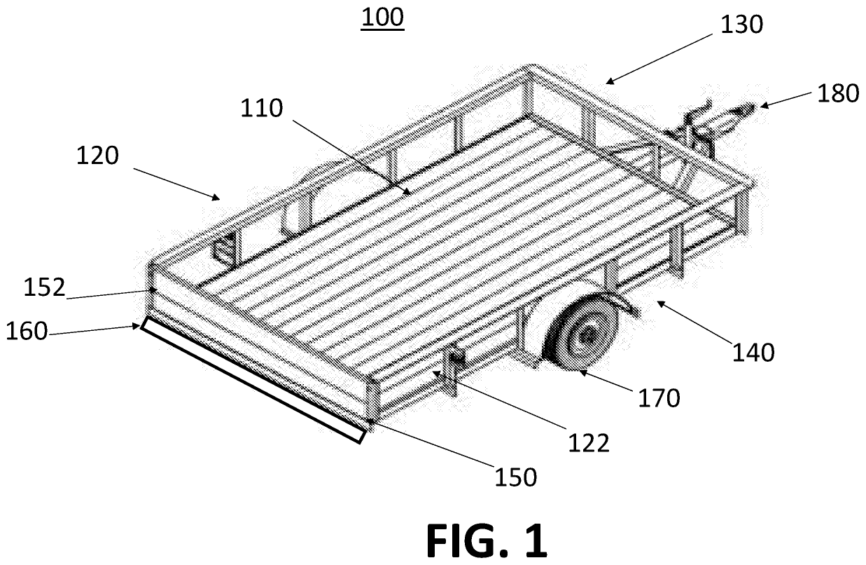

Referring to FIG. 1, is a presentation of a traditional transport trailer 100. The transport trailer 100 has a storage compartment 110 or floor, a left side 120, a back side 130, a right side 140, an open side 150, a bumper 160, a plurality of wheels 170 and a hitch 180. The transport trailer 100 is traditionally rectangular and useful for transporting large amounts of equipment or heavy equipment from one location to another location.

The hitch 180 is useful to couple the transport trailer 100 to a vehicle for easily moving the transport trailer 100 and the cargo to another location. The hitch 180 normally is a ball and hitch combination where the transport trailer 100 has a hitch 180 and the vehicle has a ball where the hitch fits onto the ball and a coupling is tightened to make a secure connection.

The left side 120, the back side 130, and the right side 140 are traditionally enclosed with a removable rail 122. The removable rail 122 may be made of any material such as steel, aluminum, etc. and may further have a covering such as a tarp like fabric, a fencing, etc. The removable rail 122 may be secured at the corners of the left side 120, back side 130 and the right side 140. The removable rail 122 is useful in securing the cargo while in transit to another location.

The storage compartment 110 of the transport trailer 100 is an open area where cargo is stored for transport. The storage compartment 110 is generally a flat surface, also referred to as the floor of the transport trailer, and allows for any type of cargo to be placed into the transport trailer. The storage compartment 110 may be made of any material such as a metal like steel or aluminum, wood, etc.

The open side 150 of the transport trailer 100 is generally opposite of the back side 130 of the transport trailer 100 and the furthest away from the hitch 180 and vehicle used for relocating the cargo to another location.

The open side 150 optionally has a bumper 160 for protection of the transport trailer 100 when the transport trailer is being backed up and may contact another trailer, vehicle or non-movable object.

The open side 150 also optionally has a gate 152, the gate 152 has the same purpose as the removable railing 122, which is to secure the cargo in the storage compartment 110 of the transport trailer 100. The gate 122 may be made of any material such as steel, aluminum, etc. and may further have a covering such as a tarp like fabric, a fencing, etc. The gate 122 is generally removable and hinged at the corners so as to allow the gate 122 to be removed to bring cargo onto the storage compartment 110 or to remove cargo from the storage compartment 110.

Not shown is a ramp which may be used to help load cargo onto the storage compartment 110. The ramp, in the traditional case, are generally ramps that are manually placed onto the back of the transport trailer 100 in the open side 150. The ramps may be stored and take up room in the storage compartment 110 when in transit or when the transport trailer 100 is not in use.

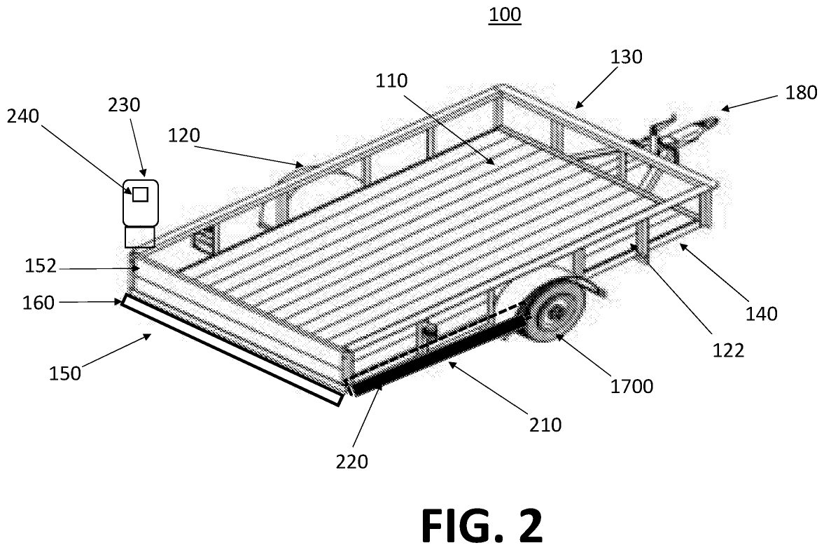

Referring now to FIG. 2, an exemplary transport trailer 100 is presented with a stowed ramp. The transport trailer 100 has a storage compartment 110 or floor, a left side 120, a back side 130, a right side 140, an open side 150, a bumper 160, a plurality of wheels 170 and a hitch 180. The transport trailer 100 is traditionally rectangular and useful for transporting large amounts of equipment or heavy equipment from one location to another location.

The hitch 180 is useful to couple the transport trailer 100 to a vehicle for easily moving the transport trailer 100 and the cargo to another location. The hitch 180 normally is a ball and hitch combination where the transport trailer 100 has a hitch 180 and the vehicle has a ball where the hitch fits onto the ball and a coupling is tightened to make a secure connection.

The left side 120, the back side 130, and the right side 140 are traditionally enclosed with a removable rail 122. The removable rail 122 may be made of any material such as steel, aluminum, etc. and may further have a covering such as a tarp like fabric, a fencing, etc. The removable rail 122 may be secured at the corners of the left side 120, back side 130 and the right side 140. The removable rail 122 is useful in securing the cargo while in transit to another location.

The storage compartment 110 of the transport trailer 100 is an open area where cargo is stored for transport. The storage compartment 110 is generally a flat surface, also referred to as the floor of the transport trailer, and allows for any type of cargo to be placed into the transport trailer. The storage compartment 110 may be made of any material such as a metal like steel or aluminum, wood, etc.

The open side 150 of the transport trailer 100 is generally opposite of the back side 130 of the transport trailer 100 and the furthest away from the hitch 180 and vehicle used for relocating the cargo to another location.

The open side 150 optionally has a bumper 160 for protection of the transport trailer 100 when the transport trailer is being backed up and may contact another trailer, vehicle or non-movable object.

The open side 150 also optionally has a gate 152, the gate 152 has the same purpose as the removable railing 122, which is to secure the cargo in the storage compartment 110 of the transport trailer 100. The gate 122 may be made of any material such as steel, aluminum, etc. and may further have a covering such as a tarp like fabric, a fencing, etc. The gate 122 is generally removable and hinged at the corners so as to allow the gate 122 to be removed to bring cargo onto the storage compartment 110 or to remove cargo from the storage compartment 110.

The transport trailer 100 also has a storage area for a ramp 210, i.e. ramp storage area 220. The ramp storage area 210 is located under the storage compartment 110 of the transport trailer 100. The ramp storage area 220 secures the ramp 210 away from the cargo in the storage compartment 110 when the ramp 210 is not being used and when the transport trailer 100 is in transit moving the cargo. The ramp 210 is slidely coupled to the transport trailer 100 and is engaged with guides in the ramp storage area 220. The ramp 210 may slide into and out of the ramp storage area 220 from the open side 150 of the transport trailer 100.

The transport trailer may optionally have a control box 230 for controlling and automating the ramp 210 being slid into and out of the ramp storage area. The automation or control of the movement of the ramp 210 is useful for those cases where the one loading the cargo does not have easy access to engage the ramp 210. The control box 230 has at least an actuator 240 for controlling the movement of the ramp 210. The actuator 240 may be touch screen, toggle switch, etc. The control box 230 may be accessed, in another embodiment, remotely. The control box 230 may have a wireless receiver (not shown) and may receive signals from a wireless transmitter (not shown) to actuate the movement of the ramp 210.

One example is a person who is in a wheel chair, when the person in the wheel chair wishes to put their wheel chair on the storage compartment 110, they need to remove the gate 150 and then slide the ramp 210 from the ramp storage area 220. This may be overwhelming or hard to do, thus a mechanism to automate the ramp 210 being inserted into or removed from the ramp storage area 220 is beneficial.

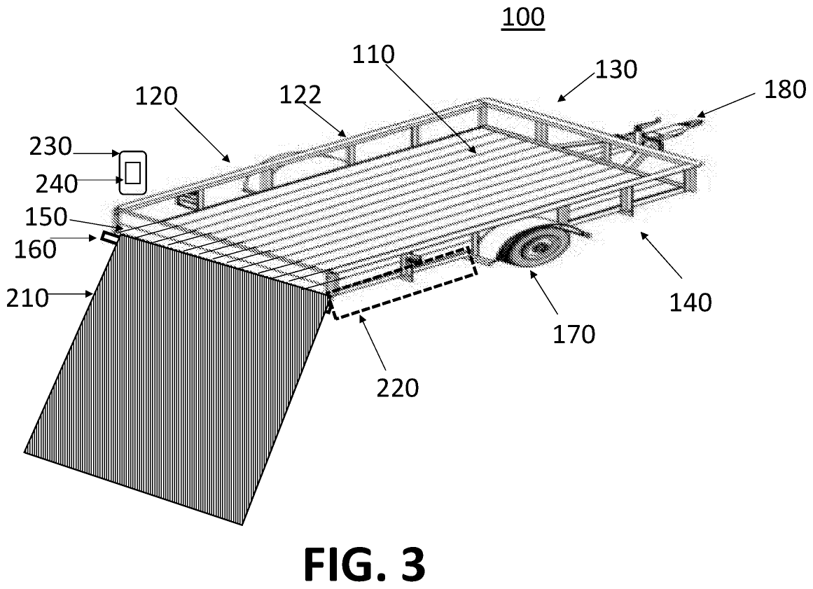

Moving now to FIG. 3, the exemplary transport trailer 100 is presented with the ramp 210 extended. The transport trailer 100 is now ready to have cargo secured in the storage area 210 or to have cargo removed from the storage area 210. The ramp 210 is slid out of the ramp storage area 220 toward the open end 150 of the transport trailer 100.

Prior to the ramp 210 being slid from the ramp storage area 220, the gate 152 is removed from the open side 150 of the transport trailer 100. The ramp 210 is slid out of the ramp storage area 220 and a proximal end 310 of the ramp 210 is secured at the open side 150 of the transport trailer where the ramp 210 is above the bumper 160, if the transport trailer 100 has a bumper 160, and the ramp 210 the area vacated by removing the gate 152. A distal end 320 of the ramp 210 is secured by placing the distal end 320 of the ramp 210 on the ground or other solid surface.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An improved transport trailer, the trailer comprising:
a storage compartment, wherein the storage compartment having a bottom, a front side, a left side, a back side, a right side and at least two wheels;
the left side, back side and the right side having a barrier, wherein the barrier being for keeping items in the storage compartment when the storage compartment is in transit;
the open side having a ramp, wherein the ramp being for moving items in and out of the storage compartment; and
the bottom having a ramp storage area, wherein the ramp storage area is for storing the ramp.

2. The improved transport trailer of claim 1, further comprising a motor and a controller, the motor being coupled to the ramp, wherein when the controller is operated the motor causes the ramp to move.

3. The improved transport trailer of claim 2, wherein the controller is actuated in a closing position, the ramp is moved into the ramp storage area.

4. The improved transport trailer of claim 2, wherein the controller is actuated by a wireless signal.

5. The improved transport trailer of claim 4, wherein the wireless signal is Bluetooth.

6. The improved transport trailer of claim 2, wherein the controller is actuated in a closing position, the ramp is slidedly moved out of the ramp storage area and hingedly attached to the opening side of the storage compartment

7. The improved transport trailer of claim 1, wherein the ramp storage area being metal.

8. The improved transport trailer of claim 1, wherein the barrier is removable.

9. The improved transport trailer of claim 1, wherein the barrier being metal.

10. The improved transport trailer of claim 1, wherein the ramp storage area being open adjacent to the open end of the storage compartment.

11. The improved transport trailer of claim 1, wherein each of the at least two wheels having tires.

12. The improved transport trailer of claim 11, wherein the tires being rubber.
